(19) United States
(12) Patent Application Publication
(10) Pub. No.: US 2003/0218860 A1
(43) Pub. Date: Nov. 27, 2003

(54) Personal computers having a plurality of displays

(75) Inventor: Shinichiro Shiraiwa, Nagoya-shi (JP)

Correspondence Address: CONLEY ROSE, P.C., P. O. BOX 3267, HOUSTON, TX, 77253-3267, US

(73) Assignee: Production Technology Corporation, Nagoya-shi (JP)

(21) Appl. No.: 10/153,954

(22) Filed: May 23, 2002

(51) Int. Cl. G06F 1/16

(52) U.S. Cl. 361/681; 361/683

(57) ABSTRACT

A computer (e.g., a laptop computer) may include a keyboard and/or other devices for inputting data. A processor may receive and process the input data. At least first and second display portions may be pivotally coupled to each other and may display images based upon instructions from the processor. Preferably, the second display portion is arranged and constructed to pivotally move relative to the first display portion.

### BACKGROUND OF THE INVENTION

1. Field of the Invention

The present invention relates to personal computers. More particularly, the present invention relates to laptop computers that have a plurality of pivotally coupled display devices.

2. Description of the Related Art

FIG. 10 shows an example of a known laptop computer 50 that includes a single display device 52 movably or rotatably connected by a pair of hinges 53a and 53b to a frame 51. The display device 52 has a display surface 52a. A data input unit 51a (i.e., a keyboard) is disposed on the frame 51.

Generally speaking, the display device 52 is positioned so that an operator (not shown) can easily view the display surface 52a along the direction of arrow 61. Therefore, in order for another person (e.g., a spectator) to view the display surface 52a when the operator operates the computer 50, the spectator typically must move behind of the operator. As a result, two people usually can not easily and comfortably view the display surface 52a simultaneously.

### SUMMARY OF THE INVENTION

It is, accordingly, one object of the present teachings to provide improved personal computers. For example, in one aspect of the present teachings, a plurality of displays or display portions may be utilized so that two or more people may simultaneously view images displayed by the computer in a comfortable manner.

In another aspect of the present teachings, laptop computers may include a data input means, including but not limited to a keyboard, disk drive, data input port and/or a touchpad. A variety of data input means may be utilized with the present teachings. A data processing means, such as a microprocessor, may receive and process data from the data input means. A variety of data processing means may be utilized with the present teachings. Results from the data processing means may be displayed upon a display means, such as a liquid crystal display (LCD) or other flat panel display. The display means may include a first display portion that is arranged and constructed to pivotally move in one direction relative to a second display portion. In this case, two separate LCDs or flat panel displays may be electrically coupled to the data processing means so as to simultaneously display the same image(s) or to display different images.

For example, the first display portion may appropriately positioned or oriented with respect to the second display portion so that an operator may view the first display portion and a spectator may view the second display portion. In this case, the operator and the spectator may simultaneously and conveniently view the displayed contents or images of the computer without interfering with each other.

In another aspect of the present teachings, the first and second display portions may respectively be directed toward different directions (e.g., substantially opposite directions). Optionally, a hinge may pivotally couple the second display portion to the first display portion. The second display portion may display images that differ from the first display portion. In addition or the alternative, the second display portion may display the same images as the first display portion.

In another aspect of the present teachings, the second display portion may further move (e.g., pivot or rotate) in a second direction relative to the first display portion, so as to turn over. For example, the hinge may include a headed pin-and-shouldered recess joint that pivotally couples the first display portion to the second display portion.

Other objects, features and advantage of the present invention will be ready understood after reading the following detailed description together with the accompanying drawings and the claims.

### BRIEF DESCRIPTION OF THE DRAWINGS

FIG. 1 is a side view of a laptop computer according to a first representative embodiment of the present teachings, illustrating a condition in which the laptop computer is folded for storage;

FIG. 2 is a side view of the laptop computer of FIG. 1, illustrating a condition in which the laptop computer has been opened for use;

FIG. 3 is a plan view of FIG. 2;

FIG. 4 is a perspective view of a laptop computer according to a second representative embodiment of the present teachings, illustrating a condition in which the laptop computer is folded for storage;

FIG. 5 is a perspective view of the laptop computer of FIG. 4, illustrating the laptop computer in a partially opened state;

FIG. 6 is a perspective view of the laptop computer of FIG. 4, illustrating the laptop computer in another partially opened state;

FIG. 7 is a perspective view of the laptop computer of FIG. 4, illustrating a condition when the laptop computer has been opened for use;

FIG. 8 is an enlarged partially cross-sectional view taken along line VIII-VIII shown in FIG. 4;

FIG. 9 is a schematic block diagram of a representative circuit that may be utilized with the laptop computers according to the first and second representative embodiments; and

FIG. 10 is a perspective view of a known laptop computer.

### DETAILED DESCRIPTION OF THE INVENTION

In another embodiment of the present teachings, laptop computers may include at least first and second displays (or first and second display portion). The second display may be arranged and constructed to pivotally rotate in a first direction relative to the first display. Optionally, the second display portion may be arranged and constructed to further pivotally rotate in a second direction with respect to the first display portion, so as to turn over. The first direction may be perpendicular, or substantially perpendicular to the second direction.

In another embodiment of the present teachings, computers (e.g., laptop computers) may include means for inputting data, including but not limited to a keyboard, a disk drive, a data input port and/or a touchpad. A processor and memory may be coupled to the data input means. At least first and second displays may be arranged and constructed to display images based upon instructions from the processor. Further, the second display is preferably arranged and constructed to pivotally move in a first direction relative to the first display.

In another embodiment of the present teachings, a hinge may pivotally couple the first display to the second display, so as to permit pivotal movement in the first direction. Optionally, the hinge may further include a headed pin-and-shouldered recess joint. In this case, the second display can pivotally move in a second direction with respect to the first display. Further, the first display optionally may be arranged and constructed to be directed towards a different direction from the second display. For example, the first display may be further arranged and constructed to be directed towards a substantially opposite direction from the second display. Moreover, the second display portion may display the same images as the first display and/or may display images that are different the images displayed by the first display.

Representative examples of the present teachings will now be described in further detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the detailed description may not be necessary to practice the invention in the broadest sense, and are instead taught merely to particularly describe detailed representative examples of the present teachings. Moreover, the various features taught in this specification may be combined in ways that are not specifically enumerated in order to obtain additional useful embodiments of the present teachings.

First Detailed Representative Embodiment

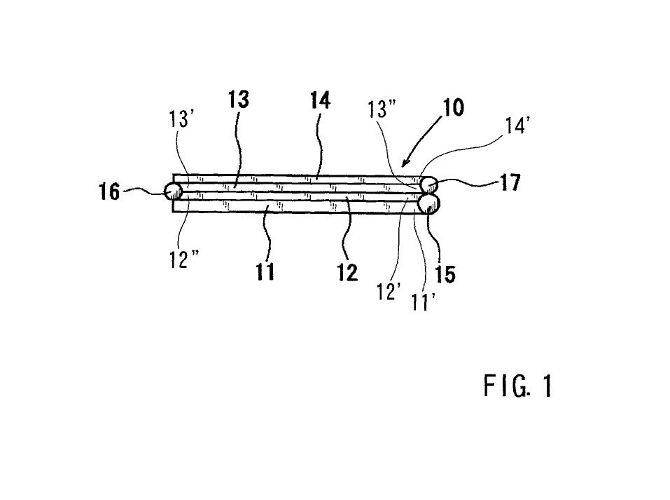

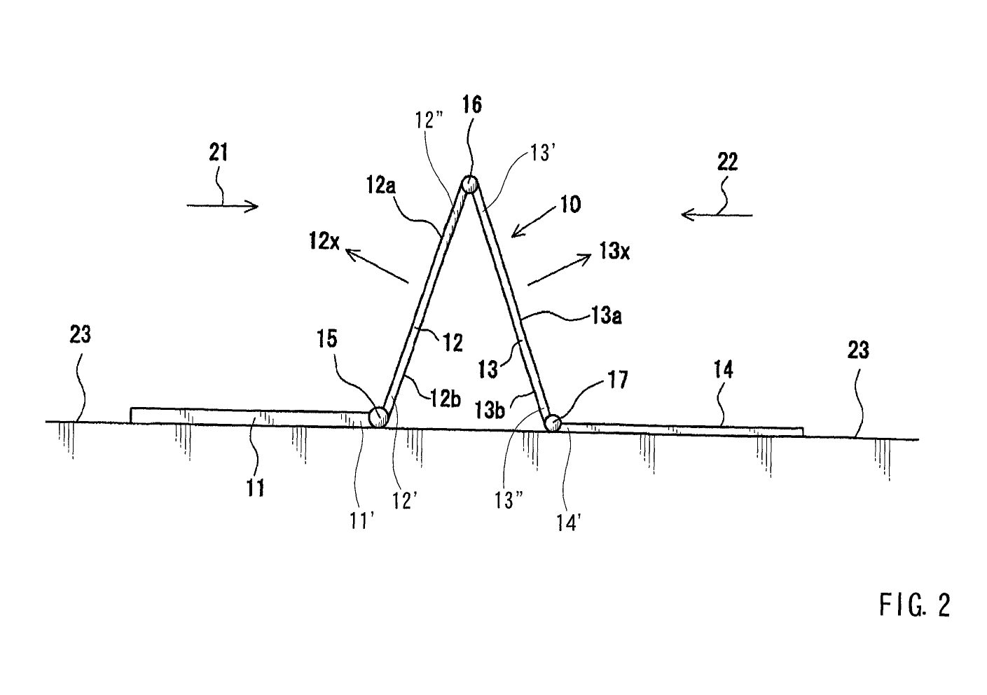

A first detailed representative embodiment of the present teachings is shown in FIGS. 1 to 3, in which a laptop computer is exemplified as a type of personal computer that may be appropriately utilized with the present teachings. Referring to FIGS. 1 and 2, the laptop computer 10 may generally include four computer components, i.e., a frame 11 that includes connecting edge 11′, a first display device 12 that includes first and second connecting edges 12′ and 12″, a second display device 13 that includes first and second connecting edges 13′ and 13″, and a lid 14 that includes connecting edge 14′. The connecting edge 11′ of the frame 11 may be movably or rotatably connected to the first connecting edge 12′ of the first display device 12 via hinge 15. The second connecting edge 12″ of the first display devices 12 may be movably or rotatably connected to the first connecting edge 13′ of the second display device 13 via a connector or hinge 16. Further, the second connecting edge 13″ of the second display device 13 may be movably or rotatably connected to the connecting edge 14′ of the lid 14 via hinge 17. Thus, the frame 11, the first and second display devices 12 and 13 and the lid 14 are movably integrated, so that the laptop computer 10 can be opened or closed.

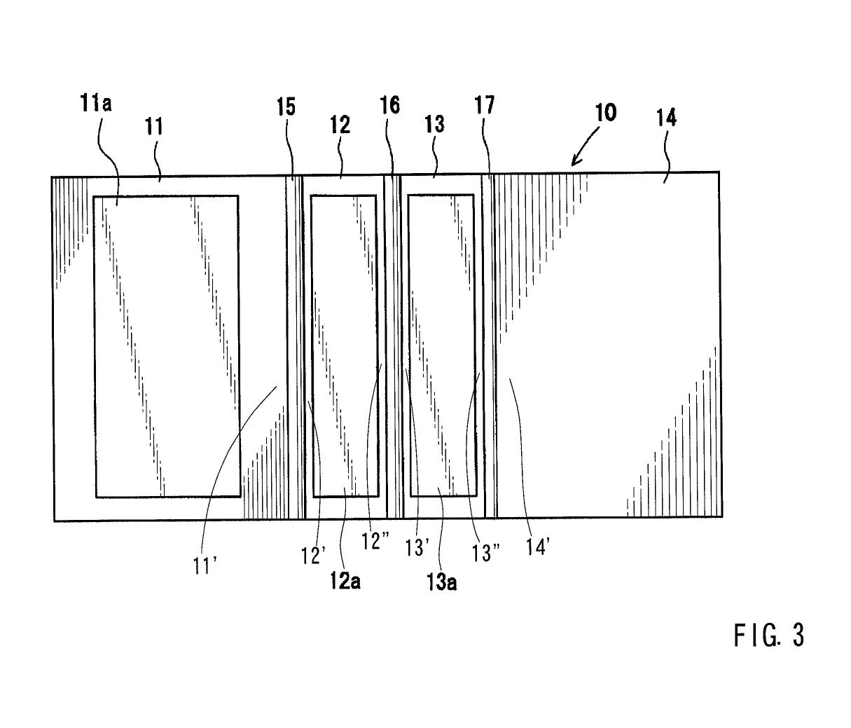

A data input means unit 11a (e.g., keyboard, disk drive, data input port and/or touchpad) may be disposed on the frame 11 for data entry (FIG. 3). Although the second display device 13 may display the same images as the first display device 12, the second display device 13 also may be arranged and constructed to display images that differ from the first display device 12. This aspect of the present teachings will be further described below.

As best shown in FIG. 2, the first display device 12 includes a front or display surface 12a and a rear surface 12b. Similarly, the second display device 13 includes a front or display surface 13a and a rear surface 13b. As will be appreciated, the first and second display devices 12 and 13 are arranged such that the first display rear surface 12b faces the second display rear surface 13b when the laptop computer 10 is folded or closed.

A representative method for using the laptop computer 10 will now be described. As shown in FIG. 2, the laptop computer 10 may be simply unfolded or opened on a surface 23 such that the first and second display devices 12 and 13 stand at an angle with respect to each other. In order to open the laptop computer 10, the second display device 13 may be pivotally rotated about the hinge 16. That is, the second display device 13 may be pivotally rotated in one direction relative to the first display device 12. When the computer 10 is opened in this manner, the respective front surfaces 12a and 13a of the first and second display devices 12 and 13 will be directed toward opposite directions as shown by arrows 12x and 13x. As a result, these display surfaces 12a and 13a can be seen from the respective directions shown by arrows 21 and 22, when the laptop computer 10 is opened.

Thus, an operator (not shown) of the computer 10 may view the display surface 12a of the first display device 12 from the direction shown by arrow 21. Further, a spectator (not shown) may view the display surface 13a of the second display device 13 from the direction shown by arrow 22. That is, the operator and the spectator may concurrently view the respective display surfaces 12a and 13a of the first and second display devices 12 and 13 from opposite directions. Therefore, the operator and the spectator may simultaneously view the displayed images from the computer 10 without interfering each other. Naturally, the laptop computer 10 may be easily folded or closed by reversing the steps that were described above.

Second Detailed Representative Embodiment

A second detailed representative embodiment of the present teachings is shown in FIGS. 4 to 8. Similar to the first representative embodiment, a laptop computer is exemplified as a type of personal computer that may be appropriately utilized with the present teachings.

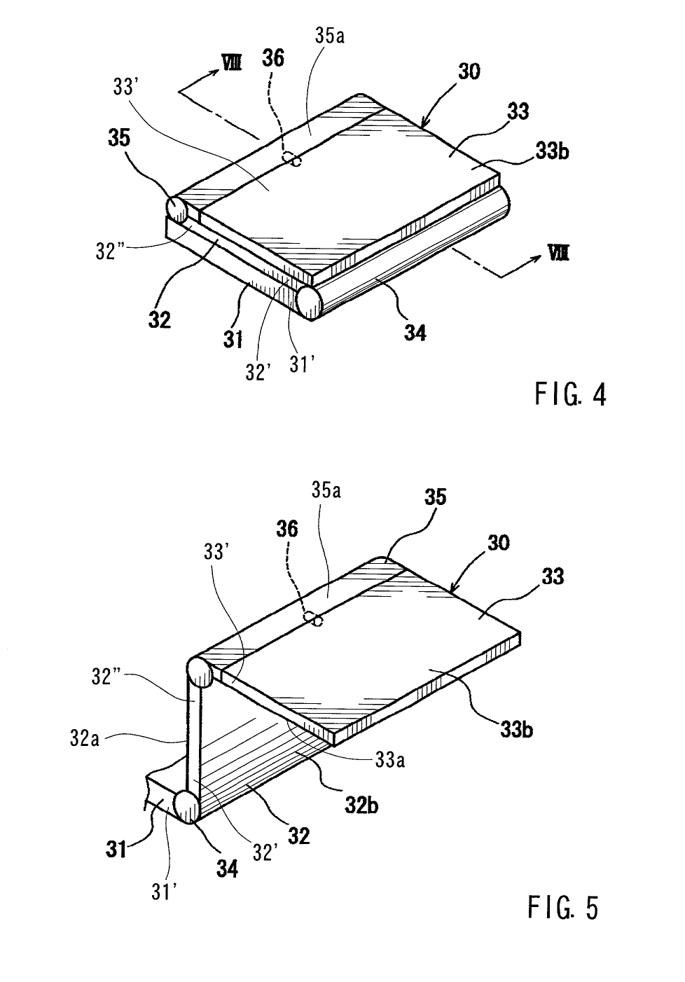

Referring to FIGS. 4 and 5, laptop computer 30 may generally include three computer components, i.e., a frame 31 that includes connecting edge 31′, a first display device 32 that includes first and second connecting edges 32′ and 32″, and a second display device 33 that includes connecting edge 33′. The connecting edge 31′ of the frame 31 may be movably or rotatably connected to the first connecting edge 32′ of the first display device 32 via hinge 34. The second connecting edge 32″ of the first display devices 32 may be movably or rotatably connected to the connecting edge 33′ of the second display device 33 via a connector or hinge 35. Thus, the frame 31, the first display devices 32, and the second display devices 33 are movably integrated, so that the laptop computer 30 can be opened or closed.

Similar to the frame 11 of the first representative embodiment, a data input means (not shown) may be disposed on the frame 31. Moreover, although the second display device 33 may display the same images as the first display device 32, the second display device 33 also may display images that differ from the first display device 32. This aspect of the present teachings will be further described below.

Unlike the hinge 16 of the first embodiment, the connecting edge 33′ of the second display device 33 is movably connected to the hinge 35 and not is rigidly or integrally connected to the hinge 35. For example, an extended portion 35a may extend along the periphery of the hinge 35. Further, the connecting edge 33′ of the second display device 33 may be movably connected to the hinge extended portion 35a such that the second display device 33 can rotate, so as to turn over.

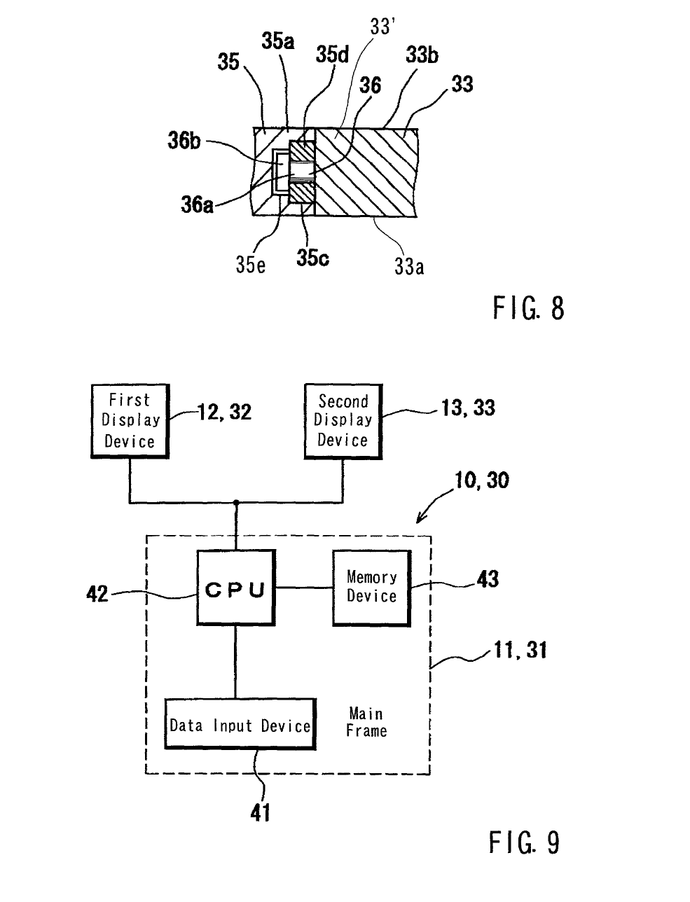

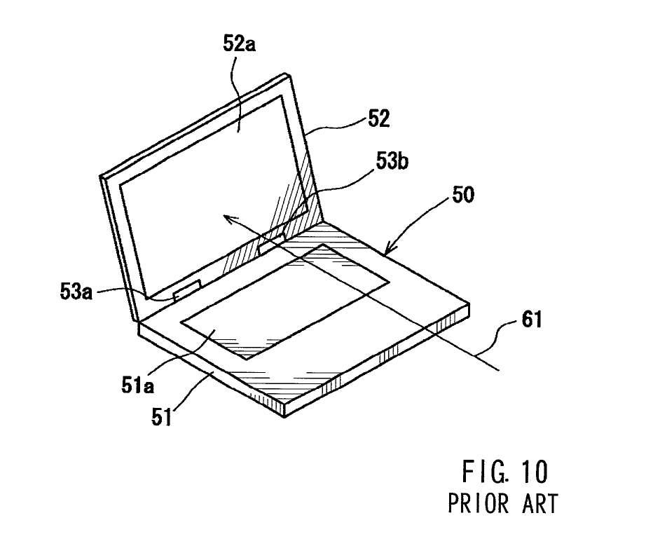

In one preferred embodiment shown in FIG. 8, a connector pin 36 may extend or project from the connecting edge 33′ of the second display device 33. The connector pin 36 may include an enlarged head portion 36b and a shank 36a. The shank 36a may be fixedly connected to or embedded within the connecting edge 33′ of the second display device 33. Thus, the pin 36 may be fixedly attached to the second display device 33.

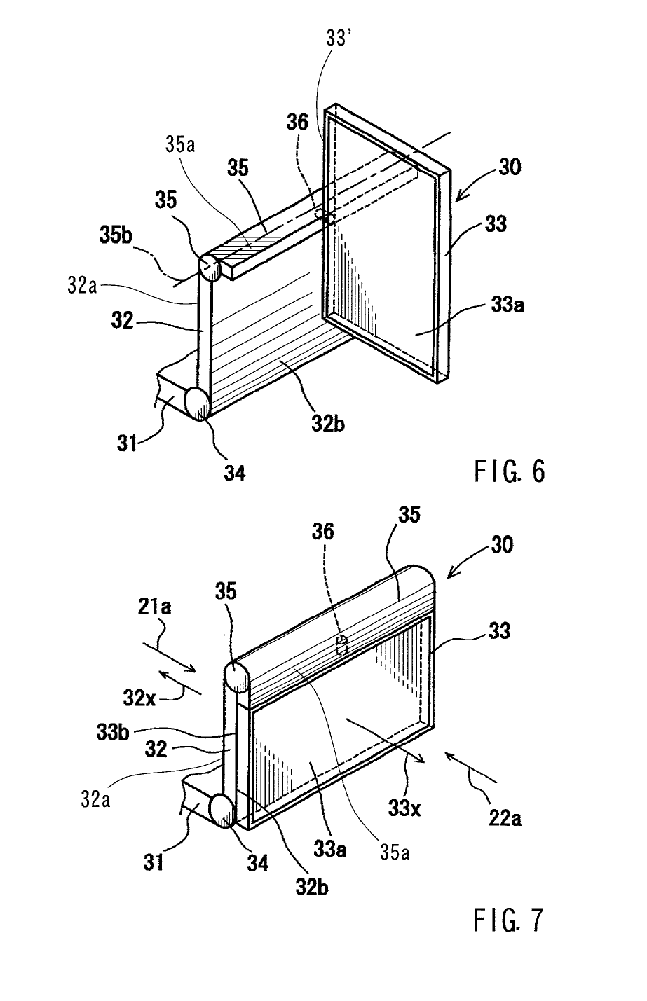

Further, the extended portion 35a of the hinge 35 may also include a shouldered bore 35c that closely receives a ring member 35d, thereby defining a shouldered recess 35e having a T-shaped cross-section. The shouldered recess 35e may be substantially complementary in shape to the head portion 36b of the connector pin 36. In addition, the connector pin 36 may be coupled to (or disposed within) the T-shaped recess 35e such that the pin head portion 36b engages the enlarged portion of the recess 35e, to thereby define a headed pin-and-shouldered recess joint. In this case, the pin 36 can move or rotate within the recess 35e without slipping out of the recess 35e. As a result, the second display device 33 can be freely rotated or pivoted with respect to the hinge 35, so as to turn over, as shown in FIG. 6. That is, the second display portion can be further rotated with respect to the first display portion.

In an alternative embodiment, the pin 36 may be attached to the hinge 35 and the recess 35e may be defined in the second display device 33, if so desired.

Referring to FIGS. 5 and 6, the first display device 32 may include a front or display surface 32a and a rear surface 32b. Similarly, the second display device 33 may include a front or display surface 33a and a rear surface 33b. Unlike the first and second display devices 12 and 13, however, the first and second display devices 32 and 33 are arranged such that the front surface 33a of the second display device 33 faces the rear surface 32b of the first display device 32 when the laptop computer 30 is folded or closed. Thus, in the second representative embodiment, the second display device 33 also may function as a lid of the computer 30 when it is closed.

A representative method for using the present laptop computer 30 will now be described. First, as shown in FIG. 5, the laptop computer 30 may be unfolded or opened such that the respective first and second display devices 32 and 33 are substantially vertically and horizontally oriented. Further, the second display device 33 may be rotated around the hinge 35. That is, the second display device 33 is rotated in one direction relative to the first display device 32.

Thereafter, the second display device 33 may be pivotally rotated about the connector pin 36, so as to turn over, as shown in FIG. 6. That is, the second display device 33 may be rotated in first and second directions relative to the first display device 32. Subsequently, the second display device 33 may be rotated around the hinge 35 in the reverse direction, so as to be adjacent to the first display device 32, as shown in FIG. 7. Thus, the first and second display devices 32 and 33 may be vertically oriented in such a manner that the first display rear surface 32b faces the second display rear surface 33b. When the computer 30 is opened in this manner, the respective front surfaces 32a and 33a of the first and second display devices 32 and 33 are directed toward opposite directions as shown by arrows 32x and 33x. As a result, similar to the first representative embodiment, the respective display surfaces 32a and 33a may be viewed from the directions shown by arrows 21a and 22a, when the laptop computer 30 is opened.

Thus, similar to the first representative embodiment, an operator (not shown) of the computer 30 may view the display surface 32a of the first display device 32 from the direction shown by arrow 21a in FIG. 7. On the other hand, a spectator (not shown) may view the display surface 33a of the second display device 33 from the direction shown by arrow 22a in FIG. 7. That is, the operator and the spectator may concurrently view the respective display surfaces 32a and 33a of the first and second display devices 32 and 33 from opposite directions. Thus, the operator and the spectator may simultaneously view the displayed images of the computer 30 without interfering each other. Naturally, the laptop computer 30 also may be easily folded or closed by simply reversing the steps that were described above.

Although a variety of hardware systems may be utilized with the present teachings, a representative electric circuit for the laptop computers 10 and 30 of the first and second representative embodiments will now be described with reference to FIG. 9. Naturally, the electric circuit of FIG. 9 is not intended to limit the scope of the present teachings in any manner and is simply provided to describe one representative embodiment of this aspect of the present teachings. Persons skilled in the art may freely modify this aspect of the present teachings.

Referring to FIG. 9, the representative electric circuit may optionally include a data input device 41 that preferably may be coupled to the data input means 11a. For example, the data input device 41 may be utilized to input data into a data processing means (e.g., CPU) 42 and a memory device 43. For example, the CPU 42 may process or operate on the data received from the data input device 41 or data stored in the memory device 43. The results of the processing may be output to the first display devices 12 and 32 and the second display devices 13 and 33.

As was mentioned above, the representative electric circuit may be designed such that the second display devices 13 and 33 may display the same contents or images as the first display devices 12 and 32. In addition or in the alternative, the computer electric circuit may be designed such that the second display devices 13 and 33 display contents or images that differ from the first display devices 12 and 32. For example, the representative electric circuit may be designed such that the first display devices 12 and 32 display first images based upon specific data and the second display devices 13 and 33 display second images based on functions of these specific data. Simply stated, the representative computer circuit may permit the spectator to view the same images as the operator or permit the spectator to view images that are different from the images viewed by the operator.

Although in each of the representative embodiments, two display devices are provided on the laptop computer, three or more display devices can be provided, if necessary or desired. Further, although hinges interconnect the computer components in each of the representative embodiments, simple flexible connector sheets (e.g., leather sheets) may connect these computer components, if necessary or desired. In other words, the computer components may be flexibly or foldably connected each other using a variety of connectors.

Further, in each of the representative embodiments, the first and second display devices are constructed and arranged such that their display surfaces can be directed toward opposite directions when the computer is opened. However, these display devices can be constructed and arranged such that their display surfaces can be directed toward a variety of directions (e.g., substantially parallel directions). Such a construction can be easily performed by simply changing the position or the type of the connector that interconnects the first and second display devices. For example, a ball-and-socket connector may be used instead of the hinge in order to interconnect the first and second display devices. In this case, the second display device can freely move or pivot in nearly any direction. According to such a construction, the first and second display devices can be, e.g., respectively directed toward parallel directions. As a result, the operator and the spectator can sit side-by-side in order to view the respective display surfaces of the first and second display devices.

Moreover, the present teachings are not limited to any particular type of personal computer, although the present teachings may be particularly advantageously utilized with laptop computers. For example, the present teachings also can be applied to desktop laptop computers, book-sized laptop computers, notebook-sized laptop computers, palm-sized computer or other types of personal computers.

1. A computer comprising:
means for inputting data,
means for processing data input by the data input means, and
means for displaying images based upon instructions from the data processing means, wherein the display means includes at least first and second display portions, the second display portion being arranged and constructed to move in a first direction relative to the first display portion.

2. A computer as defined in claim 1, wherein the first display portion is arranged and constructed to be directed towards a different direction from the second display portion.

3. A computer as defined in claim 2, wherein the first display portion is arranged and constructed to be directed towards a substantially opposite direction from the second display portion.

4. A computer as defined in claim 1, wherein the second display portion is arranged and constructed to display the same images as the first display portion.

5. A computer as defined in claim 1, wherein the second display portion is arranged and constructed to display images different from the first display portion.

6. A computer as defined in claim 1, further comprising a hinge that pivotally couples the first display portion to the second display portion.

7. A computer as defined in claim 1, wherein the second display portion is further arranged and constructed to further move in a second direction with respect to the first display portion, so as to turn over.

8. A computer as defined in claim 7, further comprising a hinge that pivotally couples the first display portion to the second display portion, so as to pivotally move in the first direction.

9. A computer as defined in claim 8, wherein the hinge further comprises a headed pin-and-shouldered recess joint, wherein the second display portion can pivotally move in the second direction with respect to the first display portion.

10. A computer as defined in claim 9, wherein the first display portion is arranged and constructed to be directed towards a different direction from the second display portion.

11. A computer as defined in claim 10, wherein the first display portion is arranged and constructed to be directed towards a substantially opposite direction from the second display portion.

12. A computer as defined in claim 11, wherein the second display portion is arranged and constructed to display the same images as the first display portion.

13. A computer as defined in claim 12, wherein the second display portion is further arranged and constructed to display images that are different from the first display portion.

14. A computer as defined in claim 9, wherein the second display portion is arranged and constructed to display the same images as the first display portion.

15. A computer as defined in claim 9, wherein the second display portion is arranged and constructed to display images that are different from the first display portion.

16. A computer comprising:
means for inputting data,
a processor and memory coupled to the data input means, and
at least first and second displays arranged and constructed to display images based upon instructions from the processor, wherein the second display is arranged and constructed to pivotally move in a first direction with respect to the first display.

17. A computer as defined in claim 16, further comprising a hinge that pivotally couples the first display to the second display, so as to permit pivotal movement in the first direction.

18. A computer as defined in claim 17, wherein the hinge further comprises a headed pin-and-shouldered recess joint, wherein the second display can move in a second direction with respect to the first display, the second direction being substantially perpendicular to the first direction.

19. A computer as defined in claim 18, wherein the first display is arranged and constructed to be directed towards a different direction from the second display and wherein the first display is further arranged and constructed to be directed towards a substantially opposite direction from the second display.

20. A computer as defined in claim 19, wherein the second display is arranged and constructed to both display (i) the same images as the first display and (ii) images that are different the images displayed by the first display.
